(19) United States
(12) Patent Application Publication
(10) Pub. No.: US 2015/0079617 A1
(43) Pub. Date: Mar. 19, 2015

(54) METHOD FOR DETERMINING BIOCHEMICAL PARAMETERS OF A BODY FLUID

(71) Applicants: Piotr Garstecki, Warszawa (PL); Marcin Izydorzak, Warszawa (PL); Magdalena Sulima, Kazanow (PL); Adam Warchulski, Milanowek (PL)

(72) Inventors: Piotr Garstecki, Warszawa (PL); Marcin Izydorzak, Warszawa (PL); Magdalena Sulima, Kazanow (PL); Adam Warchulski, Milanowek (PL)

(21) Appl. No.: 14/359,184

(22) PCT Filed: Sep. 12, 2012
(86) PCT No.: PCT/EP2012/067861

§ 371 Date: Nov. 25, 2014

(30) Foreign Application Priority Data
Nov. 21, 2011 (PL) P-397071

(51) Int. Cl. G01N 21/75

(52) U.S. Cl. CPC G01N 21/75
USPC 435/15; 436/171; 435/21; 435/26

(57) ABSTRACT

The invention relates to a method for determining biochemical parameters of a body fluid, wherein a sample of said body fluid in the form of a droplet is transported through a channel of a microfluidic system using a carrier liquid, mixed with a reagent thus initiating a chemical reaction between the sample and the reagent, and the result of the chemical reaction is measured, preferably with a spectrophotometer, whereby the said biochemical parameters of the body fluid are determined, characterised in that the material used for fabrication of the microfluidic system and the said carrier liquid is pair of Teflon and Fluorinert HFE-7100.

The invention relates to a method for determining a set of biochemical parameters in body fluids such as blood, blood serum or blood plasma. The invention comprises also the use of specially selected pairs of materials and liquids for determining biochemical parameters of a body fluid.

The state of the art knows many diagnostic methods in this study referred to as biochemical methods aiming at quantitative measurement (determination) of biochemical parameters of blood. At present, known groups of such assays of biochemical parameters include: assays of substrates, enzymes, electrolytes, specific proteins, monitoring of concentrations of drugs and intoxicants, concentrations of hormones, cancer markers, cytokines and other types of proteins, as well as all other parameters that can be determined using photometric methods. These assays can be performed in various materials of human or animal (veterinary) origin, including: whole blood, serum, plasma, cerebrospinal fluid, urine or other fluids from body cavities. These tests are usually performed in analytical laboratories by laboratory diagnosticians or medical testing technicians (material taken from humans) or in veterinary practices by trained personnel (material from animals). More and more often, however, such testing is performed as a part of a point-of-care or individual diagnostics outside the analytical laboratory, in emergency stations, intensive care units, specialised ambulances, directly by physicians, paramedics, nurses or other trained personnel.

For obvious reasons, the equipment used for individual or point-of-care assays should be easily portable, capable of providing test results within single minutes, and first of all such equipment must be reliable. In this context reliability shall mean the metrological reliability, i.e., the level of accuracy and reproducibility of the results obtained with a given instrument.

The development of microfluidics has enabled fabrication of a series of small, portable constructions that might be applied in medical diagnostics, especially in the area of individual or point-of-care diagnostics [e.g., A. Arora, G. Simone, G. B. Salieb-Beugelaar, J. T. Kim, A. Manz, Analytical Chemistry 82, 4830 (2010)]. In the underlying assumptions, these constructions are capable of making use of droplet flows [e.g., A. B. Theberge, F. Courtois, Y. Schaerli, M. Fischlechner, C. Abell, F. Hollfelder, W. T. S. Huck, Angewandte Chemie International Edition, 49, 5846 (2010)], i.e., such ones where two immiscible phases, such as water and oil, are introduced into a microfluidic system. In analogy to emulsification processes, the phase used to form droplets is referred to as the dispersed phase, and the phase in which the droplets are suspended is referred to as the continuous (dispersing) phase. The droplets (or bubbles), surrounded by another fluid spontaneously assume a spherical shape; when squeezed by channel walls they assume a shape of flattened ellipsoids or discs. It has been shown already that such systems are suitable for determining both single biochemical parameters and sets of multiple biochemical parameters using a single device.

It is a necessary prerequisite for formation of and control over a droplet flow that the dispersed phase does not wet the walls of the system (channels), as opposed to the continuous phase that must superbly wet the walls. Since biochemical assays use a very broad variety of reagents, a very important technical issue is to select the polymer used to fabricate the microfluidic system and the continuous liquid so, that no reagent, or at most possibly a few reagents only wet the channel walls in the presence of the continuous liquid. Likely, the assayed material (e.g., human or animal blood serum) must not wet the channel walls in the presence of the continuous liquid.

The Authors of the present invention have tested a very broad set of reagents for biochemical blood testing and a broad range of polymers and continuous liquids, and found unexpectedly preferred combination of polymer and continuous liquid that allow performing biochemical assays inside droplets formed and residing in the microfluidic systems, i.e., in microchannels inside the microfluidic cartridges.

In particular, the Authors of the present invention have confirmed that particularly preferred combinations were composed of polymer materials commonly used in industry: polypropylene, polyethylene and cyclic olefin copolymer (COC). These materials performed very well in a combination with oil—hexadecane. The droplets formed on the surfaces of these materials in the presence of hexadecane had a large contact angle, and the parameter is of key importance in forming droplets in a system. Unexpectedly, satisfactory results were obtained for the combination of Teflon and Fluorinert.

According to the invention, the method for determining biochemical parameters of a body fluid, wherein a sample of said body fluid in the form of a droplet is transported through a channel of a microfluidic system using a carrier liquid, mixed with a reagent thus initiating a chemical reaction between the sample and the reagent, and the result of the chemical reaction is measured, preferably with a spectrophotometer, whereby the said biochemical parameters of the body fluid are determined, is characterised in that the material used for fabrication of the microfluidic system and the said carrier liquid is pair of Teflon and Fluorinert.

Preferably, the said reagent is selected from the group comprising: acp (acid phosphatase), alat (alanine aminotransferase), albumin, alp (alkaline phosphatase), alpha-fetoprotein, alpha-1-microglobulin, amylase, asat (aspartate transaminase), aso (anti-streptolysin O), bil direct (direct bilirubin), bil total (total bilirubin), calcium, ceruloplasmin, cholesterol, cholinesterase, ck (creatine kinase), ck MB (creatine kinase MB), complement C3, complement C4, crp (C-reactive protein), cystatin C, D-dimer D, ethanol, phenobarbital, ferrum, ferritin, fibrinogen, ggt (gamma-glutamyltransferase), glucose, haptoglobin, hbdh (α-hydroxybutyrate dehydrogenase), hdl cholesterol, HbA1C (haemoglobin), immunoglobulin A, immunoglobulin E, immunoglobulin M, carbamazepine, creatinine, alpha-1-acid glycoprotein, ldh (lactate dehydrogenase), Idl cholesterol, lipase, lipoprotein, Mg (magnesium), copper, myoglobin, lactates, paracetamol, phosphorus, potassium, rf (rheumatoid factor), salicylates, sodium, theophylline, tg (triglycerides), total protein, ua (uric acid), uibc (unsaturated iron binding capacity), urea, urine protein.

The invention comprises also the use of a pair of the material and the liquid—Teflon and Fluorinert—for determining biochemical parameters of a body fluid.

### DETAILED DESCRIPTION OF THE INVENTION

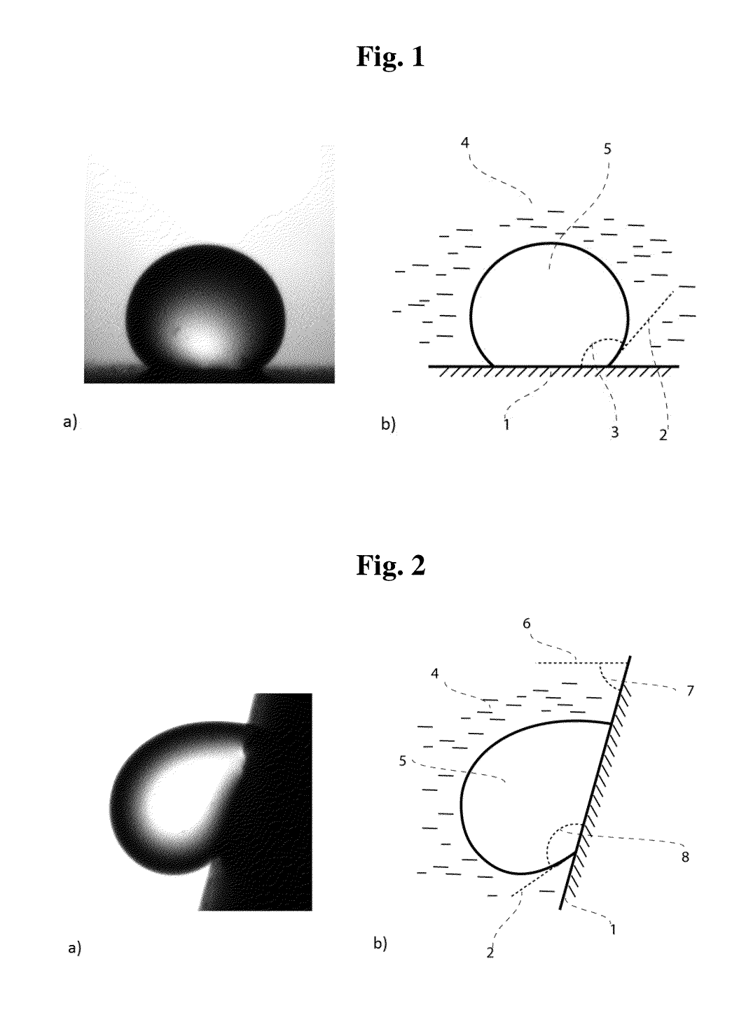

FIG. 1 shows a picture (a) and a schematic drawing (b) of a droplet observed in static position (after placing directly on the plate). The digits in part (b) of FIG. 1 have the following meaning: 1-polymer substrate; 2-tangent line to the interface of the dispersed phase; 3-static contact angle; 4-continuous fluid surrounding the droplet; 5-reagent droplet.

FIG. 2 shows a picture (a) and a schematic drawing (b) of a droplet observed in dynamic situation (observation of the contact angle while changing the inclination of the plate). The digits in part (b) of FIG. 2 have the following meaning: 1-polymer substrate; 2-tangent line to the interface of the dispersed phase; 4-continuous fluid surrounding the droplet; 5-reagent droplet; 6-parallel line to the polymer substrate in the initial position; 7-angle of inclination of the polymer plate (minimum angle required for a droplet to flow); 8-dynamic contact angle.

In a non-limiting embodiment, the static 3 and the dynamic 8 contact angles are determined, said angles formed by the serum 5 and the biochemical reagents 5 with the surface 1 of the polymer plate in the atmosphere of the selected continuous fluid 4. In a non-limiting example, the following continuous fluids 4 were tested: hexadecane, silicon oil with a viscosity of 20 cSt, paraffin oil, mineral oil, Fluorinert FC 3283, Fluorinert FC 40, Fluorinert HFE 7100. The following polymer substrates 1 were used in tests: Dyneon, Teflon, polydimethylsiloxane (PDMS), polystyrene, polyethylene, polypropylene (two types, in the following referred to as PP and PPR), styrene—prop-2-enonitrile copolymer (SAN), polystyrene GPPS and polycarbonate, cyclic olefin copolymer (two types, in the following referred to as COC 5013 and COC 6015).

The wetting of substrates 1 by reference normal (HN) and pathological (HP) serum 5 was tested. The HN/HP serum is produced on the basis of the human serum. It is used as a measurement control of concentrations of organic and inorganic components, and of the activity of enzymes. Most parameters tested in the HN serum are within the range of normal values for adults, whereas the parameters obtained for HP mostly differ from the values considered as normal. The dynamic contact angle was also studied for serums with various dilutions. The dilution was performed using physiological saline (0.9% sodium chloride).

Table 1 shows a list of biochemical assays and the volume ratio of reagents and serum used in the reaction (markings: S-serum, R1-reagent 1, R2-reagent 2). Depending on the parameter being determined, single-reagent (R1) or dual-reagent (R1 and R2) reagents were used. For most items, the Table shows English reagent abbreviations with full names given in parentheses.

TABLE 1

| Tested parameter | Method type | S [μl] | R1 [μl] | R2 [μl] |
|---|---|---|---|---|
| acp (acid phosphatase) | colorimetric | 25 | 250 | |
| alat (alanine aminotransferase) | kinetic | 100 | 1000 | 250 |
| albumin | colorimetric | 10 | 2000 | |
| alp (alkaline phosphatase) | colorimetric | 20 | 1000 | 250 |
| alpha-fetoprotein | immunoturbidimetric | 18 | 150 | 75 |
| amylase | kinetic | 5 | 250 | |
| asat (aspartate transaminase) | kinetic | 100 | 1000 | 250 |
| aso (anti-streptolysin O) | immunoturbidimetric | 6 | 200 | 140 |
| bil direct (direct bilirubin) | colorimetric | 50 | 800 | 100 |
| bil total (total bilirubin) | colorimetric | 10 | 280 | 70 |
| calcium | colorimetric | 3 | 300 | |
| ceruloplasmin | immunoturbidimetric | 5 | 250 | 50 |
| chol (cholesterol) | colorimetric, enzymatic | 3 | 250 | |
| cholinesterase | kinetic | 4 | 200 | 50 |
| ck (creatine kinase) | kinetic | 40 | 1000 | 200 |
| ck MB (creatine kinase MB) | kinetic, immunoinhibition | 20 | 200 | 50 |
| complement C3 | immunoturbidimetric | 4 | 250 | 50 |
| complement C4 | immunoturbidimetric | 7 | 250 | 50 |
| crp (C-reactive protein) | immunoturbidimetric | 4 | 200 | 200 |
| cystatin C | immunoturbidimetric | 3 | 180 | 30 |
| D-dimer D | immunoturbidimetric | 5 | 150 | 50 |
| ethanol | enzymatic | 3 | 300 | |
| phenobarbital | immunoturbidimetric | 2 | 280 | 75 |
| ferrum | colorimetric | 20 | 200 | 50 |
| ferritin | immunoturbidimetric | 10 | 100 | 50 |
| ggt (gamma-glutamyltransferase) | colorimetric | 100 | 1000 | 250 |
| glucose | colorimetric, enzymatic | 10 | 1000 | |
| haptoglobin | immunoturbidimetric | 2 | 250 | 50 |
| hbdh (α-hydroxybutyrate | kinetic | 20 | 1000 | 250 |
| dehydrogenase) | | | | |
| hdl cholesterol | enzymatic | 10 | 100 | 50 |
| HbA_{1C} (haemoglobin) | immunoturbidimetric | 5 | 210 | 70 |
| IgA (immunoglobulin A) | immunoturbidimetric | 3 | 250 | 50 |
| IgE (immunoglobulin E) | immunoturbidimetric | 5 | 200 | 100 |
| IgM (immunoglobulin M) | immunoturbidimetric | 3 | 250 | 50 |
| carbamazepine | immunoturbidimetric | 2 | 220 | 60 |
| creatinine | colorimetric; Jaffe | 100 | 1000 | 250 |
| enzymatic creatinine | enzymatic, colorimetric | 30 | 900 | 300 |
| alpha-1-acid glycoprotein | immunoturbidimetric | 3 | 250 | 50 |
| ldh (lactate dehydrogenase) | kinetic | 20 | 1000 | 250 |
| ldl cholesterol | enzymatic | 10 | 100 | 50 |
| lipase | colorimetric | 5 | 100 | 50 |
| lipoprotein | immunoturbidimetric | 6 | 180 | 90 |
| Mg (magnesium) | colorimetric | 3 | 250 | |
| myoglobin | immunoturbidimetric | 5 | 150 | 50 |
| lactates | colorimetric | 3 | 300 | |
| phosphorus | colorimetric | 3 | 300 | |
| rf (rheumatoid factor) | immunoturbidimetric | 8 | 240 | 80 |
| theophylline | immunoturbidimetric | 3 | 300 | 50 |
| tg (triglycerides) | enzymatic, colorimetric | 10 | 1000 | |
| total protein | colorimetric | 3 | 300 | |
| ua (uric acid) | enzymatic, colorimetric | 20 | 1000 | 250 |
| uibc (unsaturated iron binding | colorimetric | 15 | 200 | 50 |
| capacity) | | | | |
| urea | enzymatic, kinetic | 10 | 1000 | 250 |
| urine protein | colorimetric | 12.5 | 250 | |

In the following part of the description we refer to the measurements of the static angle 3—the angle formed between the polymer substrate 1 and the plane 2 tangent to the interface of the dispersed phase 5 and the continuous phase 4 under static conditions, on a horizontally placed substrate (FIG. 1), and to the measurements of the dynamic angle 8, that is the largest angle between the interface 2 of the dispersed phase 5 and the continuous phase 4, and the plane 1 of the polymer substrate, above which the droplet flew down from the substrate. The dynamic angle 8 was measured by slow inclining the substrate 1. The dynamic angle 8 and the angle of inclination 7 of the substrate, at which the droplet starts to flow down the substrate, were measured. The measurements were carried out on substrates entirely immersed in a tub filled with continuous liquid 4.

In the case of some materials (polypropylene, polyethylene), two plate types were used in tests. In the first case, the surface of the plate was roughened, i.e., the plate had a number of unevennesses (notches) on the surface. In this case, reagent droplets were dispensed perpendicularly to the unevennesses (notches) to check the effect of surface unevennesses on the dynamic contact angle. The second type of the plate surface was the even surface. In a non-limiting embodiment, even plates are fabricated by casting the polymer on a polished metal matrix (e.g., aluminium or steel one). In a non-limiting embodiment, manipulations with droplets on the polymer substrates mentioned in the present patent application can be made at room temperature.

To assure that the results are clearer, hereinafter we use the following markings coding the minimum inclination of the substrate 1, for which the droplet started to flow:
−− the droplet did not flow down the plate even for the maximum inclination (90°),
− the droplet flew down for the plate inclination in the range 40-70°,
+ the droplet flew down for the plate inclination in the range 10-40°,
++ the droplet flew down for the plate inclination in the range 0-10°,
+++ the droplet flows immediately after placing.

Where the dynamic angle 8 is not given in the tables below, then it means that for a given inclination 7 the droplet flew so fast that taking a picture was very difficult.

In a non-limiting embodiment, the following, not much preferable angles were measured for reagents deposited on a substrate made of PDMS in the atmosphere of a silicon oil with a viscosity of 20 cSt (HP—pathological serum; HN—normal serum; e.g., x2—it means that the serum was diluted twice;)

| | Static | Dynamic | Substrate |
|---|---|---|---|
| Reagent | angle | angle | inclination |
| Water | 150.6 | 154.6 | − |
| Physiological | 152.3 | 157.2 | − |
| saline | | | |
| HPx4 | 139.4 | 145.6 | −− |
| HPx16 | 142.6 | 148.3 | − |

In a non-limiting embodiment, the following contact angles were measured for reagents deposited on a substrate made of PDMS and surface-modified with Aquapel (waterproof silane-siloxane sealer) in the atmosphere of Fluorinert 3283 fluorinated oil.

| | static |
|---|---|
| Reagent | angle |
| HN | 136.6 |
| HNx2 | 127.8 |
| HNx8 | 123.6 |
| HNx16 | 119.9 |
| HP | 121.1 |
| HPx2 | 121.3 |
| HPx4 | 122.2 |
| HPx8 | 119.1 |
| HPx16 | 121.9 |

In a non-limiting embodiment, the following contact angles were measured for reagents deposited on a substrate made of polypropylene (PPR) in the atmosphere hexadecane oil. The PPR substrate was roughened.

| | Static | Dynamic | Substrate |
|---|---|---|---|
| | angle | angle | inclination |
| Reagent | | | |
| HN | | 162.6 | +++ |
| HNx4 | 152.6 | | +++ |
| HNx16 | 149 | 152.4 | +++ |
| HP | | 152.5 | +++ |
| HPx4 | 146 | 154.1 | +++ |
| HNx4 | | | +++ |
| HPx16 | 153.4 | 156.1 | +++ |
| Water | | 159.6 | +++ |
| Physiological saline | 154.6 | 157.2 | ++ |
| ACP | 134.2 | 145.2 | −− |
| Mixture ACP + HN | 102.6 | 107.6 | −− |
| Alat R1 | | 156.7 | +++ |
| Alat R2 | | | +++ |
| Mixture Alat + HN | | | +++ |
| Albumin | | | +++ |
| Mixture albumin + HN | | 153.5 | +++ |
| ALP R2 | 146.7 | 158.6 | ++ |
| Mixture ALP + HN | 149 | 150.5 | ++ |
| Alpha-1-acid glycoprotein R1 | 155.2 | 149.8 | + |
| Alpha-1-acid glycoprotein R2 | 150.2 | 145.5 | + |
| Mixture alpha-1-acid | | | +++ |
| glycoprotein + calibrator | | | |
| Alpha-fetoprotein R1 | 132.4 | 147.7 | + |
| Alpha-fetoprotein R2 | 142 | 144.6 | + |
| Mixture alpha-fetoprotein + | | | +++ |
| HN | | | |
| Amylase R1 | | 158.2 | +++ |
| Mixture amylase + HN | | | +++ |
| ASAT R1 | | | +++ |
| ASAT R2 | | 154.3 | +++ |
| ASO R1 | | 150.5 | +++ |
| ASO R2 | 151.9 | 144.9 | ++ |
| Mixture ASO + HN | 147.6 | 119.6 | +++ |
| Bil direct R1 | | | +++ |
| Bil direct R2 | | | +++ |
| Mixture bil direct + HN | | | +++ |
| Bil total R1 | | | +++ |
| Bil total R2 | 152.5 | 148.3 | + |
| Mixture bil total + HN | | | +++ |
| Calcium R1 | 126.8 | 104.5 | + |
| Mixture calcium + HN | 131.8 | 116.8 | ++ |
| Ceruloplasmin R1 | 148.7 | 150.8 | ++ |
| Ceruloplasmin R2 | 136.2 | 150.5 | ++ |
| Mixture ceruloplasmin + HN | 151.4 | | ++ |
| Cholesterol R1 | 123.3 | 127.5 | ++ |
| Mixture cholesterol R1 | 128.6 | 139.9 | +++ |
| Cholinesterase R1 | 147.2 | 151.8 | − |
| Cholinesterase R2 | 150.7 | 149.9 | −− |
| Mixture cholinesterase + HN | 147 | 145.3 | − |
| ck R1 | | | +++ |
| ck R2 | | | +++ |
| Mixture ck + HN | | | +++ |
| ck mb R1 | | | +++ |
| ck mb R2 | | | +++ |
| Mixture ck mb + HN | | | +++ |
| Complement C3 R1 | 152.3 | 149.3 | − |
| Complement C3 R2 | 149 | 144.6 | −− |
| Mixture complement C3 + HN | 149 | 145.3 | − |
| Complement C4 R1 | 152.2 | 153.5 | + |
| Complement C4 R2 | | 150.5 | +++ |
| Mixture complement C4 + | 149.1 | 142.2 | + |
| HN | | | |
| CRP R1 | 151.4 | 141.9 | ++ |
| CRP R2 | | | +++ |
| Mixture CRP + HN | | | +++ |
| Cystatin C R1 | 125.4 | | ++ |
| Cystatin C R2 | 122.2 | | + |
| Mixture cystatin C + HN | | 140.5 | +++ |
| D-dimer | | | +++ |
| D-dimer R1 | | | +++ |
| D-dimer R2 | | 155.9 | +++ |
| Mixture D-dimer + HN | | | +++ |
| Ethanol | | | +++ |
| Mixture ethanol + HN | | | +++ |
| Ferritin R1 | | | +++ |
| Ferritin R2 | | | +++ |
| Mixture ferritin + HN | | | +++ |
| Ferrum R1 | | | +++ |
| Ferrum R2 | | 154 | +++ |
| Mixture ferrum + HN | 133.8 | 136.9 | +++ |
| GGT R1 | | 154 | +++ |
| GGT R2 | 150.8 | 142.5 | ++ |
| Mixture GGT + HN | 147.4 | 138.4 | ++ |
| Glucose R1 | | | +++ |
| Mixture glucose + HN | | | +++ |
| Haptoglobin R1 | 148.1 | 146.7 | −− |
| Haptoglobin R2 | 140.1 | 143 | ++ |
| Mixture haptoglobin + HN | 150.1 | 143.2 | − |
| HBDH R1 | 149.3 | 154.5 | + |
| HBDH R2 | 136.8 | | + |
| Mixture HBDH + HN | | | +++ |
| Haemoglobin R1 | 148.8 | 147.6 | −− |
| Haemoglobin R2 | 122.5 | | +++ |
| Haemoglobin R2a | | | +++ |
| Haemoglobin R2b | | | +++ |
| Mixture haemoglobin + HN | | | +++ |
| HDL R1 | | 146.8 | +++ |
| HDL R2 | | | +++ |
| Mixture HDL + HN | | | +++ |
| Lipoprotein R1 | 144.4 | 143.8 | + |
| Lipoprotein R2 | 152.6 | | ++ |
| Mixture lipoprotein + HN | | | +++ |
| Lipase R1 | | 136.6 | +++ |
| Lipase R2 | | 143.5 | +++ |
| Mixture lipase + HN | | | +++ |
| LDH R1 | 156.3 | | + |
| LDH R2 | 148.6 | 158.6 | + |
| Mixture LDH + HN | | | +++ |
| LDL R1 | | | +++ |
| LDL R2 | 131.3 | 133 | + |
| Mixture LDL + HN | | 142.7 | +++ |
| Mg R1 | 121.2 | 112.6 | ++ |
| Mixture Mg + HN | 125.1 | 118.2 | + |
| Myoglobin R1 | | | +++ |
| Myoglobin R2 | | | +++ |
| Mixture myoglobin + HN | | | +++ |
| Phosphorus R1 | 123.1 | 128.3 | ++ |
| Mixture phosphorus + HN | 128.3 | 107.5 | ++ |
| RF R1 | | | +++ |
| RF R2 | | 152.7 | +++ |
| Mixture RF + HN | | | +++ |
| TG R1 | 126.1 | 130.5 | ++ |
| TG R2 | 134.8 | 129.5 | + |
| Mixture TG + HN | 126.1 | 135.8 | ++ |
| Total protein | 145.8 | 152.2 | ++ |
| Mixture total protein + HN | 152.5 | | ++ |
| UA R1 | 123.6 | 125.8 | +++ |
| UA R2 | 126 | 128.1 | ++ |
| Mixture UA + HN | 124 | 127.7 | +++ |
| UIBC R1 | 112.5 | 126.5 | ++ |
| UIBC R2 | 148.6 | 152.5 | ++ |
| Mixture UIBC + HN | 127.2 | 128.7 | ++ |
| Urea R1 | | | +++ |
| Urea R2 | 158.3 | 151.2 | + |
| Mixture urea + HN | | | +++ |
| Urine protein | | | +++ |
| Mixture urine protein + | | | +++ |
| control | | | |
| Alpha-1-microglobulin R1 | 136.2 | 144.4 | + |
| Alpha-1-microglobulin R2 | 143.8 | | ++ |
| Phenobarbital R1 | | 159.0 | +++ |
| Phenobarbital R2 | 162.4 | 152.5 | −− |
| Mixture phenobarbital + HN | 152.6 | 149.4 | ++ |
| Fibrinogen R1 | 115.3 | 120.8 | ++ |
| Fibrinogen R2 | 148.6 | 158.3 | ++ |
| IgA R1 | 147.6 | 148.6 | ++ |
| IgA R2 | | | +++ |
| Mixture IgA + control | 153.6 | 150.4 | − |
| IgE R1 | 155.3 | 153.1 | − |
| IgE R2 | 154.1 | 152.8 | + |
| Mixture IgE + control | 149.2 | 151.2 | ++ |
| IgM R1 | 151.5 | 149.4 | − |
| IgM R2 | 154.1 | 151.9 | −− |
| Mixture IgM + control | | | +++ |
| Carbamazepine R1 | 153.1 | 149.0 | − |
| Carbamazepine R2 | 145.0 | | + |
| Mixture carbamazepine + | 153.9 | | − |
| control | | | |
| Reagents without | | | |
| surfactant | | | |
| Alat R1 | 132.8 | 149.1 | + |
| Alat R2 | 149.2 | 142.3 | − |
| Mixture Alat + HN | | | +++ |
| Albumin R1 | 145 | 147.8 | − |
| Mixture albumin + HN | | | +++ |
| Ferrum R1 | 155.8 | 153 | − |
| Ferrum R2 | 152.5 | 148.5 | −− |
| Mixture ferrum + HN | | | +++ |

In a non-limiting embodiment, the following contact angles were measured for reagents deposited on an even substrate made of PPR in the atmosphere of hexadecane oil.

| | Static | Dynamic | Substrate |
|---|---|---|---|
| Reagent | angle | angle | inclination |
| ACP | | | +++ |
| Mixture ACP + HN | | | +++ |
| ALP R2 | | | +++ |
| Alpha-1-acid glycoprotein R1 | 153.8 | 148.1 | ++ |
| Alpha-fetoprotein R1 | 151.4 | 147.2 | +++ |
| Bil total R2 | 156.6 | 154.1 | ++ |
| Cholinesterase R1 | | | +++ |
| Mixture cholinesterase + HN | | | +++ |
| Complement C3 R1 | 150.6 | 146.5 | +++ |
| Complement C3 R2 | | | +++ |
| Mixture complement C3 + HN | | | +++ |
| Haptoglobin R1 | | 152 | +++ |
| Mixture haptoglobin + HN | | | +++ |
| Haemoglobin R1 | | | +++ |
| HBDH R1 | | | +++ |
| HBDH R2 | | | +++ |
| Creatinine R1 | | | +++ |
| Creatinine R2 | | 153.6 | + |
| Mixture creatinine + HN | | | +++ |
| LDH R2 | | | +++ |
| Urea R2 | | | +++ |
| Alpha-1-microglobulin R1 | | | +++ |
| Creatinine enzymatic R1 | | 151.3 | +++ |
| Creatinine enzymatic R2 | | 152.7 | +++ |
| Mixture creatinine | | 153.5 | +++ |
| enzymatic + HN | | | |
| Phenobarbital R2 | | 160 | +++ |
| Mixture IgA + control | | | +++ |
| IgE R1 | | | +++ |
| IgM R1 | | 156.6 | +++ |
| IgM R2 | | 154.1 | +++ |
| Carbamazepine R1 | | 161 | +++ |
| Mixture carbamazepine + | | | +++ |
| control | | | |
| Copper R1 | | 154.2 | +++ |
| Paracetamol R1 | | 149.2 | +++ |
| Paracetamol R2 | | | +++ |
| Potassium R1 | | 155.9 | +++ |
| Potassium R2 | | | +++ |
| Salicylates R1 | | | +++ |
| Salicylates R2 | | | +++ |
| Sodium R1 | | 153.9 | +++ |
| Sodium R2 | | | +++ |
| Alat R2 | | | +++ |
| Albumin R1 | | | +++ |
| Ferrum R1 | | 158.4 | +++ |
| Ferrum R2 | 154.6 | 154.2 | ++ |

In a non-limiting embodiment the following contact angles were measured for reagents deposited on a substrate made of PPR in the atmosphere of mineral oil.

| | Dynamic | Substrate |
|---|---|---|
| Reagent | angle | inclination |
| Water | | +++ |
| Physiological saline | 159.1 | − |
| HN | | +++ |
| HNx4 | 144.55 | ++ |
| HNx16 | 163 | +++ |
| HP | 158.05 | +++ |
| HPx4 | 161.55 | +++ |
| HPx16 | 161.9 | +++ |
| Albumin R1 + HP | 156.8 | +++ |
| Albumin R1 | 160.9 | +++ |
| Cholesterol R1 | 153.6 | +++ |

In a non-limiting embodiment, the following contact angles were measured for reagents deposited on a substrate made of PPR in the atmosphere of paraffin oil.

| | Dynamic | Substrate |
|---|---|---|
| Reagent | angle | inclination |
| Water | | +++ |
| Physiological saline | 149.4 | − |
| HN | 158.8 | ++ |
| HNx4 | 156.7 | ++ |
| HNx16 | 153 | ++ |
| HP | 156.7 | +++ |
| HPx4 | 162 | +++ |
| HPx16 | 163 | +++ |
| ALAT R1 | 159.6 | +++ |
| Albumin R1 + HN | 158.2 | +++ |
| Albumin R1 | 154.3 | ++ |
| Cholesterol R1 | 136.3 | ++ |

In a non-limiting embodiment, the following contact angles were measured for reagents, for which the results of the tests on a PPR substrate in hexadecane oil were unfavourable, on a polypropylene (PP) substrate in the atmosphere of the same oil (hexadecane).

| | Dynamic | Substrate |
|---|---|---|
| Reagent | angle | inclination |
| ACP | | +++ |
| Mixture ACP + HN | | +++ |
| ALP R2 | | +++ |
| LDH R2 | | +++ |
| Bil total R2 | 152.8 | +++ |
| Cholinesterase R1 | | +++ |
| Mixture cholinesterases + HN | 145.4 | +++ |
| Complement C3 R1 | | +++ |
| Complement C3 R2 | | +++ |
| Mixture complement C3 + HN | | +++ |
| Haptoglobin R1 | | +++ |
| Mixture haptoglobin + HN | | +++ |
| HBDH R1 | | +++ |
| HBDH R2 | | +++ |
| Urea R2 | | ++ |

In a non-limiting embodiment, the following contact angles were measured for reagents deposited on a substrate made of PP in the atmosphere of paraffin oil.

| | Dynamic | Substrate |
|---|---|---|
| Reagent | angle | inclination |
| Water | 151.5 | ++ |
| Physiological saline | 154.1 | + |
| HN | 163.7 | ++ |
| HNx4 | 165.6 | +++ |
| HNx16 | 160.7 | ++ |
| HP | 158.6 | ++ |
| HPx4 | 158.3 | +++ |
| HPx16 | 162.3 | +++ |
| ALAT R1 | 164.7 | ++ |
| Cholesterol R1 | 140.6 | ++ |

In a non-limiting embodiment, the following contact angles were measured for reagents deposited on a polyethylene substrate containing small unevennesses in the atmosphere of hexadecane oil.

| | Dynamic | Substrate |
|---|---|---|
| Reagent | angle | inclination |
| Water | | +++ |
| Physiological saline | | ++ |
| HPx16 | | +++ |
| HPx4 | | +++ |
| HP | | ++ |
| HNx16 | | +++ |
| HNx4 | | +++ |
| HN | | ++ |
| Alat R1 | | ++ |
| Alat R2 | | ++ |
| Mixture Alat + HN | | +++ |
| Mixture albumin + HN | 152.9 | ++ |
| ASO R1 | | +++ |
| ASO R2 | | +++ |
| Mixture ASO + HN | | +++ |
| Cholesterol R1 | 122.6 | ++ |
| CK R2 | 142.7 | +++ |
| CRP R1 | 131.4 | + |
| CRP R2 | | ++ |
| Mixture CRP + HN | 124.1 | ++ |
| Ethanol | | ++ |
| Mixture ethanol + HN | | +++ |
| Ferrum R1 | | +++ |
| Ferrum R2 | | ++ |
| Mixture ferrum + HN | | +++ |
| TG R1 | | + |
| TG R2 | | + |
| Mixture TG + HN | | + |
| Total protein | | ++ |
| Mixture total protein + HN | | ++ |
| UA R1 | | +++ |
| UA R2 | | +++ |
| Mixture UA + HN | | ++ |
| UIBC R1 | | + |
| UIBC R2 | | + |
| Mixture UIBC + HN | | + |

In a non-limiting embodiment, the following contact angles were measured for reagents deposited on roughened polyethylene substrate in the atmosphere of hexadecane oil.

| | Dynamic | Substrate |
|---|---|---|
| Reagent | angle | inclination |
| Alat R1 | 160.8 | +++ |
| Alat R2 | 160.5 | +++ |
| Mixture ALAT + HN | 157.4 | +++ |
| Albumin R1 | 154.4 | +++ |
| Mixture albumin + HN | 159 | +++ |
| Ferrum R1 | 149.2 | +++ |
| Ferrum R2 | 156.7 | +++ |
| Mixture ferrum + HN | 158.7 | +++ |
| ACP | 151.3 | +++ |
| Mixture ACP + HN | 152.2 | +++ |
| Amylase | | +++ |
| Mixture amylase + HN | | +++ |
| Albumin R1 | 149.6 | +++ |
| Mixture albumin + HN | | +++ |
| ALP R1 | | +++ |
| ALP R2 | 157.9 | ++ |
| Mixture ALP + HN | | +++ |
| Alpha-1-acid glycoprotein R1 | 157.1 | +++ |
| Alpha-1-acid glycoprotein R2 | 150.8 | +++ |
| Mixture alpha-1-acid | 149.4 | +++ |
| glycoprotein + HN | | |
| Alpha-fetoprotein R1 | 153.2 | +++ |
| Alpha-fetoprotein R2 | 152 | +++ |
| Mixture alpha-fetoprotein + HN | 140 | +++ |
| ASAT R1 | | +++ |
| ASAT R2 | 135.7 | +++ |
| Mixture ASAT + HN | 138 | +++ |
| Bil direct R1 | 161 | +++ |
| Bil direct R2 | 159.8 | +++ |
| Mixture bil direct + HN | 150.4 | +++ |
| Bil total R1 | 142.4 | +++ |
| Bil total R2 | 141.6 | +++ |
| Mixture bil total + HN | 137.6 | +++ |
| Calcium R1 | 133.3 | ++ |
| Mixture calcium + HN | 127.2 | + |
| Ceruloplasmin R1 | 158.8 | +++ |
| Ceruloplasmin R2 | 156.1 | +++ |
| Mixture ceruloplasmin + HN | | +++ |
| Cholesterol | | +++ |
| Mixture cholesterol + HN | 130.3 | +++ |
| Cholinesterase R1 | 145.95 | +++ |
| Cholinesterase R2 | 157.8 | +++ |
| Mixture cholinesterase + HN | 156 | +++ |
| CK R1 | 149.2 | +++ |
| CK R2 | | +++ |
| Mixture CK + HN | 144 | +++ |
| Complement C3 R1 | 156.6 | +++ |
| Complement C3 R2 | | +++ |
| Mixture complement C3 + HN | | +++ |
| Complement C4 R1 | 156.1 | +++ |
| Complement C4 R2 | 147.5 | +++ |
| Mixture complement C4 + HN | 159 | +++ |
| Cystatin C R1 | 143.4 | +++ |
| Cystatin C R2 | 140.4 | +++ |
| Mixture cystatin C + HN | 150.2 | +++ |
| D-dimer R1 | 154 | +++ |
| D-dimer R2 | | +++ |
| Mixture D-dimer + HN | | +++ |
| Ferritin R1 | 127.7 | +++ |
| Ferritin R2 | 155.5 | +++ |
| Mixture ferritin + HN | | +++ |
| GGT R1 | | +++ |
| GGT R2 | 138.6 | +++ |
| Mixture GGT + HN | 155.4 | +++ |
| Glucose R1 | 144.4 | +++ |
| Mixture glucose + HN | | +++ |
| Haptoglobin R1 | 63.6 | +++ |
| Haptoglobin R2 | 155 | +++ |
| Mixture haptoglobin + HN | | +++ |
| Haemoglobin R1 | 158 | +++ |
| Haemoglobin R2 | 143.6 | +++ |
| Haemoglobin R2a | 144.6 | +++ |
| Haemoglobin R2b | 154.2 | +++ |
| Mixture haemoglobin + HN | 142.6 | +++ |
| HBDH R1 | 157 | +++ |
| HBDH R2 | 154 | +++ |
| Mixture HBDH + HN | 138.7 | +++ |
| HDL R1 | 143.9 | +++ |
| HDL R2 | 139.4 | +++ |
| Mixture HDL + HN | 149.6 | +++ |
| Creatinine R1 | 156.6 | +++ |
| Creatinine R2 | 158.6 | +++ |
| Mixture creatinine + HN | 156.4 | +++ |
| LDH R1 | 158.8 | +++ |
| LDH R2 | 150.4 | +++ |
| Mixture LDH + HN | 150.9 | +++ |
| LDL R1 | 146.4 | +++ |
| LDL R2 | 143 | +++ |
| Mixture LDL + HN | | +++ |
| Lipase R1 | 134.1 | +++ |
| Lipase R2 | 141.6 | +++ |
| Mixture lipase + HN | 147.6 | +++ |
| Lipoprotein R1 | 141.4 | +++ |
| Lipoprotein R2 | 159 | +++ |
| Mixture lipoprotein + HN | | +++ |
| CK MB R1 | 157.9 | +++ |
| CK MB R2 | 154 | +++ |
| Mixture CK-MB + HN | 151.4 | +++ |
| MG R1 | 133.65 | +++ |
| Mixture Mg + HN | 135.1 | +++ |
| Myoglobin R1 | 153.6 | +++ |
| Myoglobin R2 | 156.9 | +++ |
| Mixture myoglobin + HN | 153.4 | +++ |
| Phosphorus | | ++ |
| Mixture phosphorus + HN | 146 | +++ |
| RF R1 | 152.6 | +++ |
| RF R2 | 159 | +++ |
| Mixture RF + HN | 155.4 | +++ |
| Urine proteins | | +++ |
| Mixture urine proteins + HN | 145.4 | +++ |
| UA R1 | 139.85 | +++ |
| UA R2 | 144.3 | +++ |
| Mixture UA + HN | | +++ |
| Urea R1 | 147.8 | +++ |
| Urea R2 | | +++ |
| Mixture urea + HN | 151.7 | +++ |
| Alpha-1-microglobulin R1 | 165.9 | +++ |
| Alpha-1-microglobulin R2 | 168.3 | +++ |
| Phenobarbital R1 | | ++ |
| Phenobarbital R2 | | ++ |
| Mixture phenobarbital + control | 159.7 | +++ |
| Fibrinogen R1 | 152.3 | ++ |
| Fibrinogen R2 | 161 | +++ |
| IgA R1 | 163.3 | +++ |
| IgA R2 | 160.8 | +++ |
| Mixture IgA + control | 157.9 | +++ |
| Ig E R1 | | +++ |
| Ig E R2 | 161.7 | +++ |
| Mixture IgE + control | 162.5 | +++ |
| Ig M R1 | | +++ |
| IgM R2 | 150.9 | ++ |
| Mixture IgM + control | 165.5 | +++ |
| Carbamazepine R1 | 160.2 | +++ |
| Carbamazepine R2 | 153.7 | +++ |
| Mixture carbamazapine + control | 161 | +++ |
| Creatinine enzymatic R1 | 156 | +++ |
| Creatinine enzymatic R2 | 160.8 | +++ |
| Mixture creatinine enzymatic + HN | 156.8 | +++ |
| Lactates | | +++ |
| Mixture Lactates + HN | | ++ |
| Theophylline R1 | 166 | +++ |
| Theophylline R2 | | +++ |
| Mixture theophylline + control | 157.1 | +++ |
| UA without surfactant R1 | 160.2 | +++ |
| UA without surfactant R2 | | ++ |
| Mixture UA without surfactant + HN | 159.4 | +++ |

In a non-limiting embodiment, the following contact angles were measured for reagents deposited on a substrate made of polyethylene in the atmosphere of mineral oil.

| | Substrate |
|---|---|
| Reagent | inclination |
| Water | +++ |
| Physiological saline | ++ |
| HNx16 | +++ |
| HNx4 | ++ |
| HN | +++ |
| HPx16 | ++ |
| HPx4 | ++ |
| HP | ++ |
| HNx4 | ++ |
| HNx16 | ++ |
| Mixture albumin + HN | ++ |
| Albumin | ++ |
| Cholesterol | ++ |
| Alat R1 | ++ |

In a non-limiting embodiment, the following contact angles were measured for reagents deposited on a substrate made of GPPS in the atmosphere of hexadecane oil.

| | Static | Dynamic | Substrate |
|---|---|---|---|
| Reagent | angle | angle | inclination |
| Water | 141.4 | | ++ |
| Physiological saline | 136.7 | | −− |
| HN | 121.2 | 133.8 | − |
| HNx4 | 138.6 | 137.6 | + |
| HNx16 | 149.5 | 139.7 | − |
| HPx4 | 86.2 | 134.0 | − |
| HPx16 | 113.4 | 111.3 | + |

In a non-limiting embodiment, the following contact angles were measured for reagents deposited on a substrate made of GPPS polystyrene in the atmosphere of mineral oil.

| | Static | Dynamic | Substrate |
|---|---|---|---|
| Reagent | angle | angle | inclination |
| Water | 68.8 | 104.2 | −− |
| Physiological saline | 106.2 | 107.2 | − |
| HN | 52.6 | 106.5 | −− |
| HNx4 | 97.8 | 100.5 | −− |
| HNx16 | 121.4 | 120.6 | + |

In a non-limiting embodiment, the following contact angles were measured for serum (HN—normal control serum, and HP—pathological control serum) and serum dilutions deposited on substrate made of dedecylamine-modified polycarbonate in the atmosphere of hexadecane oil.

| | Static |
|---|---|
| Reagent | angle |
| HN | 135.0 |
| HNx2 | 134.4 |
| HNx4 | 141.8 |
| HNx8 | 140.4 |
| HNx16 | 142.5 |
| HP | 144.6 |
| HPx2 | 146.5 |
| HPx4 | 142.3 |
| HPx8 | 147.7 |
| HPx16 | 146.9 |

In a non-limiting embodiment, the following contact angles were measured for reagents deposited on a substrate made of PS polystyrene in the atmosphere of hexadecane oil.

| | Static | Dynamic | Substrate |
|---|---|---|---|
| Reagent | angle | angle | inclination |
| Water | 131.6 | 137.2 | −− |
| Physiological saline | 148.4 | 155.6 | + |
| HN | | | +++ |
| HNx4 | 142.2 | 130.4 | ++ |
| HNx16 | 146.8 | 139.8 | ++ |
| HP | | | +++ |
| HPx4 | | | +++ |
| HPx16 | | | +++ |
| Mixture albumin + HN | | | +++ |
| Albumin (without surfactant) | | | +++ |
| Haptoglobin R1 | 147.6 | 142.7 | ++ |
| Haemoglobin R2 | 104.2 | 105.4 | − |

In a non-limiting embodiment, the following contact angles were measured for reagents deposited on a substrate made of SAN polymer in the atmosphere of mineral oil.

| | Static | Dynamic | Substrate |
|---|---|---|---|
| Reagent | angle | angle | inclination |
| Water | 135.4 | 132.6 | − |
| Physiological saline | 136.7 | 135.5 | − |
| HN | 154 | 156.5 | ++ |
| HNx4 | | | +++ |
| HNx4 | 95.8 | 154 | − |
| HNx16 | 70.5 | | − |
| HP | 113.2 | 140.7 | − |
| HPx4 | 142.3 | 154.5 | ++ |
| HPx16 | 112.6 | 116.7 | ++ |

In a non-limiting embodiment, the following contact angles were measured for reagents deposited on a substrate made of SAN polymer in the atmosphere of paraffin oil.

| | Static | Dynamic | Substrate |
|---|---|---|---|
| Reagent | angle | angle | inclination |
| Water | 128.8 | 125.4 | −− |
| Physiological saline | 112.8 | 121.8 | −− |
| HNx16 | 155.1 | 157.5 | − |

In a non-limiting embodiment, the following contact angles were measured for reagents deposited on a substrate made of Dyneon polymer in the atmosphere of Fluorinert FC-40 fluorinated oil.

| | Static | Dynamic | Substrate |
|---|---|---|---|
| Reagent | angle | angle | inclination |
| Water | 98.8 | 110.4 | −− |
| Physiological saline | 102.6 | 110.9 | − |
| HN | 122.4 | 128.4 | − |
| HNx4 | 138.1 | 136.4 | − |
| HNx16 | 132.6 | 124.3 | − |
| HPx4 | 128.2 | 123.8 | − |
| HPx16 | 110 | 130.3 | − |

In a non-limiting embodiment, the following contact angles were measured for reagents deposited on a substrate made of Dyneon polymer in the atmosphere of Fluorinert FC 3283 fluorinated oil:

| | Static | Dynamic | Substrate |
|---|---|---|---|
| Reagent | angle | angle | inclination |
| Water | 143 | 135.3 | + |
| Physiological saline | 139.7 | 131.4 | − |
| HN | 147 | 120 | −− |
| HNx4 | 137.5 | 133.5 | −− |
| HNx16 | 143.3 | 123.1 | − |
| HP | 110 | 114 | −− |
| HPx2 | 125 | 133.4 | −− |
| HPx4 | 136.5 | 133.6 | − |
| HPx8 | 113.7 | 133.8 | −− |
| HNx16 | 112.2 | | − |

In a non-limiting embodiment, the following contact angles were measured for reagents deposited on a substrate made of Dyneon polymer in the atmosphere Fluorinert FC-7100 fluorinated oil.

| | Static | Dynamic | Substrate |
|---|---|---|---|
| Reagent | angle | angle | inclination |
| Water | 75.1 | 107.7 | −− |
| Physiological saline | 152.9 | 148.4 | + |
| HN | 70.6 | | − |
| HNx4 | 79.2 | 80.7 | − |
| HNx16 | 126.7 | 112 | − |

In a non-limiting embodiment, the following contact angles were measured for reagents deposited on a substrate made of Teflon polymer in the atmosphere of Fluorinert THF 7100 fluorinated oil.

| | Static | Dynamic | Substrate |
|---|---|---|---|
| Reagent | angle | angle | inclination |
| Water | | | +++ |
| Physiological saline | 142 | | +++ |
| HN | 151.7 | 117.6 | +++ |
| HNx4 | 139.9 | 133 | +++ |
| HNx16 | | | +++ |
| HP | | 151.7 | +++ |
| HPx4 | | | +++ |
| HPx16 | | | +++ |
| ACP R1 | | 154.9 | +++ |
| Mixture ACP + HN | | | +++ |
| Alat R1 | | 158.8 | +++ |
| Alat R2 | | | +++ |
| Mixture Alat + HN | | | +++ |
| Albumin R1 | | 160.4 | +++ |
| Mixture albumin + HN | | | +++ |
| ALP R1 | | 152.2 | +++ |
| ALP R2 | | 159.1 | +++ |
| Mixture ALP + HN | | 147.7 | +++ |
| Alpha-1-acid glycoprotein R1 | | | +++ |
| Alpha-1-acid glycoprotein R2 | | | +++ |
| Mixture alpha-1-acid | | | +++ |
| glycoprotein + HN | | | |
| Alpha-fetoprotein R1 | | | +++ |
| Alpha-fetoprotein R2 | | | +++ |
| Mixture alpha-fetoprotein + | | | +++ |
| HN | | | |
| Amylase R1 | | | ++ |
| Mixture amylase + HN | | | +++ |
| Asat R1 | 151.5 | 153.7 | +++ |
| Asat R2 | 157.3 | 154.4 | + |
| Mixture Asat + HN | 149 | 139.9 | ++ |
| ASO R1 | | | +++ |
| ASO R2 | | 160.6 | +++ |
| Mixture ASO + HN | | | +++ |
| Bil total R1 | | | +++ |
| Bil total R2 | | 157.3 | +++ |
| Mixture bil total + HN | | | +++ |
| Calcium R1 | 135.6 | 141.5 | ++ |
| Mixture calcium + HN | | 144.9 | +++ |
| Ceruloplasmin R1 | | | +++ |
| Ceruloplasmin R2 | | 160.5 | +++ |
| Mixture ceruloplasmin + HN | | | +++ |
| Cholesterol R1 | 142.9 | 144.2 | ++ |
| Mixture cholesterol + HN | 140.8 | 144.6 | ++ |
| Cholinesterase R1 | | 146.9 | +++ |
| Cholinesterase R2 | | 159.8 | +++ |
| Mixture cholinesterase + HN | | 153.4 | +++ |
| CK R1 | | 157.2 | +++ |
| CK R2 | | 152.7 | +++ |
| Mixture CK + HN | | | +++ |
| ck-mb R1 | | | +++ |
| ck-mb R2 | | | +++ |
| Mixture ck-mb + HN | | | +++ |
| Complement C3 R1 | | 156.4 | +++ |
| Complement C3 R2 | | 152.7 | ++ |
| Mixture complement C3 + | | | +++ |
| HN | | | |
| Complement C4 R1 | | 148 | +++ |
| Complement C4 R2 | | | +++ |
| Mixture complement C4 + | | | +++ |
| HN | | | |
| CRP R1 | | | +++ |
| CRP R2 | | 161.4 | +++ |
| Mixture CRP + HN | | | +++ |
| Cystatin C R1 | | | +++ |
| Cystatin C R2 | | | +++ |
| Mixture cystatin C + HN | | | +++ |
| D-dimer R1 | | 154.6 | +++ |
| D-dimer R2 | | 150.1 | +++ |
| Mixture D-dimer + HN | | 148.5 | +++ |
| Ethanol R1 | | 158.1 | +++ |
| Mixture ethanol + HN | | 150.5 | +++ |
| Ferritin R1 | | | +++ |
| Ferritin R2 | | 157.3 | +++ |
| Mixture ferritin + HN | | | +++ |
| Ferrum R1 | | 136.7 | +++ |
| Ferrum R2 | | 147.4 | +++ |
| Mixture ferrum + HN | | 140.6 | +++ |
| GGT R1 | | | +++ |
| GGT R2 | | | +++ |
| Mixture GGT + HN | | | +++ |
| Glucose R1 | | 149.4 | +++ |
| Mixture glucose + HN | | 148.4 | +++ |
| Haptoglobin R1 | | | +++ |
| Haptoglobin R2 | | | +++ |
| Mixture haptoglobin + HN | | | +++ |
| Haemoglobin R1 | | 157.4 | +++ |
| Haemoglobin R2 | | 155.7 | +++ |
| Haemoglobin R2a | | | +++ |
| Haemoglobin R2b | | | +++ |
| Mixture haemoglobin + HN | | | +++ |
| HBDH R1 | | 167.9 | +++ |
| HBDH R2 | | 161.3 | +++ |
| Mixture HBDH + HN | | 145.7 | +++ |
| HDL R1 | | 155.6 | +++ |
| HDL R2 | | 160.1 | +++ |
| Mixture HDL + HN | | 152.2 | +++ |
| Creatinine R1 | | | +++ |
| Creatinine R2 | | | +++ |
| Mixture creatinine + HN | | 162.7 | +++ |
| LDH R1 | | | +++ |
| LDH R2 | 145.2 | 161.8 | ++ |
| Mixture LDH + HN | | 157.6 | +++ |
| LDL R1 | | 153.9 | +++ |
| LDL R2 | | 139.2 | +++ |
| Mixture LDL + HN | | 142.3 | +++ |
| Lipase R1 | | 156.1 | +++ |
| Lipase R2 | | 151.6 | +++ |
| Mixture lipase + HN | | 148.7 | +++ |
| Lipoprotein R1 | | | +++ |
| Lipoprotein R2 | | | +++ |
| Mixture lipoprotein + HN | | | +++ |
| MG R1 | 143.2 | 138.8 | +++ |
| Mixture Mg + HN | | 144.1 | ++ |
| Myoglobin R1 | | | +++ |
| Myoglobin R2 | | | +++ |
| Mixture myoglobin + HN | | | +++ |
| Phosphorus R1 | | 143.1 | +++ |
| Mixture phosphorus + HN | | 143 | +++ |
| RF R1 | | | +++ |
| RF R2 | | | +++ |
| Mixture RF + HN | | | +++ |
| TG R1 | 126.8 | 138 | ++ |
| TG R2 | 141.5 | 111.8 | ++ |
| Mixture TG + HN | 130.8 | 129.4 | ++ |
| Total protein R1 | | | +++ |
| Mixture total protein + HN | | | +++ |
| UA R1 | 140.8 | 142.6 | ++ |
| UA R2 | 142.9 | 143.8 | ++ |
| Mixture UA + HN | 139.3 | 137.1 | ++ |
| UIBC R1 | 128.5 | 138.4 | ++ |
| UIBC R2 | | 160.5 | +++ |
| Mixture UIBC + HN | | 137.9 | +++ |
| Urea R1 | | 143.8 | +++ |
| Urea R2 | | 158.6 | +++ |
| Mixture urea + HN | | 155.5 | +++ |
| Urine proteins R1 | 139.2 | 141.9 | ++ |
| Mixture urine proteins + HN | 145.3 | 141.9 | +++ |

| Reagents without | Dynamic | Substrate |
|---|---|---|
| surfactant | angle | inclination |
| Alat R1 | 166.8 | +++ |
| Alat R2 | | +++ |
| Mixture Alat + HN | 160 | +++ |
| Albumin R1 | | +++ |
| Mixture albumin + HN | 157.9 | +++ |
| Ferrum R1 | | +++ |
| Ferrum R2 | 148 | +++ |
| Mixture ferrum + HN | 146.4 | +++ |

In a non-limiting embodiment, the following contact angles were measured for reagents deposited on a substrate made of Teflon polymer in the atmosphere of Fluorinert FC-3283 fluorinated oil.

| | Static | Dynamic | Substrate |
|---|---|---|---|
| Reagents | angle | angle | inclination |
| Water | 136.9 | 138.4 | ++ |
| Physiological saline | 134.5 | 136.5 | ++ |
| HN | 146 | 121.5 | + |
| HNx4 | 143.4 | 138.4 | − |
| HNx8 | 130.6 | 113.4 | + |
| HNx16 | 134.5 | 136.7 | − |
| HP | 134.5 | 136 | + |
| HPx2 | 126.6 | 123.4 | + |
| HPx4 | 140.7 | 137.8 | + |
| HPx8 | 146.9 | 142.4 | + |
| HPx16 | 142.5 | 129.9 | + |

In a non-limiting embodiment, the following contact angles were measured for reagents deposited on a substrate made of cyclic olefin copolymer (COC) 5013 in the atmosphere of hexadecane oil.

| | Static | Dynamic | Substrate |
|---|---|---|---|
| Reagent | angle | angle | inclination |
| Alat R1 | 163.3 | 161.7 | +++ |
| Alat R2 | 164.3 | 164.3 | +++ |
| Albumina R1 | 156.0 | 154.2 | ++ |
| α-fetoprotein R1 | 162.5 | 160.7 | +++ |
| α-fetoprotein R2 | 158.6 | 141.0 | −− |
| Alp R1 | 163.9 | 163.9 | +++ |
| Alp R2 | 163.7 | 163.7 | +++ |
| Amylase R1 | 162.7 | 163.5 | +++ |
| Asat R1 | 162.4 | 162.2 | +++ |
| Asat R2 | 164.3 | 164.3 | +++ |
| Aso R1 | 159.8 | 159.8 | +++ |
| Aso R2 | 162.1 | 162.1 | +++ |
| Bil direct R1 | 150.8 | 150.8 | + |
| Bil direct R2 | 153.5 | 153.5 | +++ |
| Cholesterol R1 | 129.4 | 127.8 | +++ |
| CK R1 | 152.1 | 152.1 | +++ |
| CK R2 | 143.7 | 143.7 | +++ |
| CK MB R1 | 147.9 | | +++ |
| CK MB R2 | 146.1 | 146.1 | +++ |
| CRP R1 | 159.4 | 143.6 | − |
| CRP R2 | 153.0 | 150.5 | ++ |
| Cystatin R1 | 158.5 | 158.5 | +++ |
| Cystatin R2 | 143.4 | 143.4 | +++ |
| D-dimer Diluent | 145.6 | | −− |
| D-dimer R1 | 161.1 | 162.3 | + |
| D-dimer R2 | 162.4 | | −− |
| Ethanol R1 | 161.5 | 161.5 | +++ |
| Ferrum R1 | 163.4 | 163.4 | +++ |
| Ferrum R2 | 160.2 | 160.2 | +++ |
| Ferritin R1 | 158.4 | 157.2 | +++ |
| Ferritin R2 | 158.6 | 158.6 | +++ |
| GGT R1 | 162.3 | 162.3 | +++ |
| GGT R2 | 160.3 | 160.3 | +++ |
| Glucose R1 | 152.9 | 151.6 | + |
| HBDH R1 | 163.5 | 163.5 | +++ |
| HBDH R2 | 162.4 | 126.7 | + |
| HDL R1 | 162.0 | 162.2 | +++ |
| HDL R2 | 157.3 | 157.3 | +++ |
| HbA1c R1 | 163.7 | 163.7 | +++ |
| HbA1c R2a | 149.3 | 149.3 | +++ |
| HbA1c R2b | 151.2 | 156.5 | +++ |
| Creatynine R1 | 147.5 | 147.5 | +++ |
| Creatynine R2 | 158.4 | 158.4 | +++ |
| LDH R1 | 162.7 | 162.7 | +++ |
| LDH R2 | 161.3 | 161.3 | +++ |
| LDL R1 | 156.8 | 156.8 | +++ |
| LDL R2 | 134.6 | 131.7 | + |
| Lipase R1 | 151.2 | 151.2 | +++ |
| Lipase R2 | 147.2 | 147.2 | +++ |
| Lipoprotein R1 | 137.0 | 137.0 | + |
| Lipoprotein R2 | 158.0 | 142.1 | + |
| Mioglobin R1 | 161.8 | 161.8 | +++ |
| Mioglobin R2 | 160.3 | 160.3 | +++ |
| RF R1 | 156.6 | 156.6 | +++ |
| RF R2 | 150.1 | 150.1 | +++ |
| TG R1 | 136.7 | 136.7 | +++ |
| TG R2 | 142.5 | 142.5 | +++ |
| Total protein R1 | 163.5 | 156.8 | +++ |
| UA R1 | 140.6 | 138.9 | +++ |
| UA R2 | 134.0 | 134.0 | + |
| UIBC R1 | 138.4 | | + |
| UIBC R2 | 149.9 | 151.1 | + |
| Urea R1 | 155.7 | 159.6 | +++ |
| Urea R2 | 161.8 | | + |
| Urine protein R1 | 151.8 | 151.8 | +++ |
| ACP | 148.6 | 148.6 | + |
| Calcium R1 | 145.5 | | + |
| Ceruloplasmin R1 | 157.5 | 157.5 | +++ |
| Ceruloplasmin R2 | 154.4 | 154.4 | +++ |
| Cholinesterase R1 | 158.9 | 158.9 | +++ |
| Cholinesterase R2 | 157.7 | 157.7 | +++ |
| Complement C3 R1 | 158.0 | 158.0 | +++ |
| Complement C3 R2 | 157.5 | 159.4 | +++ |
| Complement C4 R1 | 156.2 | 156.2 | +++ |
| Complement C4 R2 | 154.6 | 154.6 | +++ |
| HN | 157.6 | 157.6 | +++ |
| Water | 155.2 | 155.2 | +++ |

In a non-limiting embodiment, the following contact angles were measured for reagents deposited on a substrate made of cyclic olefin copolymer 6015 in the atmosphere of hexadecane oil.

| | Static | Dynamic | Substrate |
|---|---|---|---|
| Reagent | angle | angle | inclination |
| Alat R1 | 162.7 | 164.1 | + |
| Alat R2 | 162.3 | 147.0 | + |
| Albumin R1 | 160.2 | 134.6 | + |
| α-fetoprotein R1 | 155.6 | 149.8 | −− |
| α-fetoprotein R2 | 159.2 | 159.2 | +++ |
| Alp R1 | 151.3 | 148.4 | −− |
| Alp R2 | 152.2 | 152.2 | + |
| Asat R1 | 160.8 | | −− |
| Asat R2 | 159.9 | 162.4 | − |
| Aso R1 | 163.5 | 131.7 | − |
| Aso R2 | 157.9 | 157.9 | + |
| Bil direct R1 | 146.6 | 146.6 | +++ |
| Bil direct R2 | 152.1 | 152.1 | +++ |
| Cholesterol R1 | 126.8 | 141.5 | +++ |
| CK R1 | 140.7 | 147.2 | + |
| CK R2 | 143.6 | 143.6 | +++ |
| CK MB R1 | 139.9 | 139.9 | +++ |
| CK MB R2 | | 130.8 | +++ |
| D-dimer Diluent | 155.7 | | −− |
| D-dimer R1 | 153.8 | 148.3 | −− |
| D-dimer R2 | 135.5 | | −− |
| Ethanol R1 | 162.1 | 162.1 | +++ |
| Ferrum R1 | 134.7 | 134.7 | +++ |
| Ferrum R2 | 156.3 | 157.4 | + |
| Ferritin R1 | 158.8 | 152.9 | + |
| Ferritin R2 | 157.8 | 157.8 | +++ |
| GGT R1 | 164.0 | 164.0 | −− |
| GGT R2 | 160.1 | 146.7 | +++ |
| Glucose R1 | 162.6 | 162.6 | +++ |
| HBDH R1 | 146.4 | 140.7 | −− |
| HBDH R2 | 148.3 | 137.1 | −− |
| HDL R1 | 160.4 | 160.4 | +++ |
| HDL R2 | 152.6 | 152.6 | +++ |
| HbA1c Hemolysing | 150.7 | 139.7 | +++ |
| HbA1c R2a | 151.2 | 138.8 | ++ |
| HbA1c R2b | 130.6 | 132.0 | +++ |
| Creatynine R1 | 158.9 | 158.9 | +++ |
| Creatynine R2 | 158.0 | 158.0 | +++ |
| LDL R1 | 128.2 | 129.2 | + |
| LDL R2 | 99.4 | 99.4 | +++ |
| Lipase R1 | 120.0 | 120.0 | +++ |
| Lipase R2 | 136.0 | 131.6 | ++ |
| RF R1 | 141.4 | 134.7 | +++ |
| RF R2 | 160.9 | 160.9 | +++ |
| HN | 154.9 | 157.0 | +++ |
| TG mono | 126.4 | 128.7 | ++ |
| Water | 160.5 | 160.5 | +++ |

Considering the conditions mentioned in the introduction, based on the measurements of contact angles, the Authors of the present invention have unexpectedly discovered that the most preferred combination of polymer and continuous liquid for performing biochemical assays in droplets manipulated inside microfluidic cartridges is Teflon and Fluorinert HFE-7100.

The Authors of the present invention have unexpectedly discovered that the combination of Teflon and Fluorinert HFE-7100 enable controlled formation of droplets of biochemical reagents (Table 2) and manipulating these droplets inside microchannels or microchambers in the microfluidic cartridges.

TABLE 2

| Tested parameter | Method type |
|---|---|
| acp (acid phosphatase) | colorimetric |
| alat (alanine aminotransferase) | kinetic |
| albumin | colorimetric |
| alp (alkaline phosphatase) | colorimetric |
| alpha-fetoprotein | immunoturbidimetric |
| alpha-1-microglobulin | immunoturbidimetric |
| amylase | kinetic |
| asat (aspartate transaminase) | kinetic |
| aso (anti-streptolysin O) | immunoturbidimetric |
| bil direct (direct bilirubin) | colorimetric |
| bil total (total bilirubin) | colorimetric |
| calcium | colorimetric |
| ceruloplasmin | immunoturbidimetric |
| cholesterol | colorimetric, enzymatic |
| cholinesterase | kinetic |
| ck (creatine kinase) | kinetic |
| ck MB (creatine kinase MB) | kinetic, immunoinhibition |
| complement C3 | immunoturbidimetric |
| complement C4 | immunoturbidimetric |
| crp (C-reactive protein) | immunoturbidimetric |
| cystatin C | immunoturbidimetric |
| D-dimer D | immunoturbidimetric |
| ethanol | enzymatic |
| phenobarbital | immunoturbidimetric |
| ferrum | colorimetric |
| ferritin | immunoturbidimetric |
| fibrinogen | immunoturbidimetric |
| ggt (gamma-glutamyltransferase) | colorimetric |
| glucose | colorimetric, enzymatic |
| haptoglobin | immunoturbidimetric |
| hbdh (α-hydroxybutyrate | kinetic |
| dehydrogenase) | |
| hdl cholesterol | enzymatic |
| HbA_{1C} (haemoglobin) | immunoturbidimetric |
| immunoglobulin A | immunoturbidimetric |
| immunoglobulin E | immunoturbidimetric |
| immunoglobulin M | immunoturbidimetric |
| carbamazepine | immunoturbidimetric |
| creatinine | colorimetric; Jaffe |
| creatinine | enzymatic, colorimetric |
| alpha-1-acid glycoprotein | immunoturbidimetric |
| ldh (lactate dehydrogenase) | kinetic |
| ldl cholesterol | enzymatic |
| lipase | colorimetric |
| lipoprotein | immunoturbidimetric |
| Mg (magnesium) | colorimetric |
| copper | colorimetric |
| myoglobin | immunoturbidimetric |
| lactates | colorimetric |
| paracetamol | colorimetric |
| phosphorus | colorimetric |
| potassium | colorimetric |
| rf (rheumatoid factor) | immunoturbidimetric |
| salicylates | colorimetric |
| sodium | colorimetric |
| theophylline | immunoturbidimetric |
| tg (triglycerides) | enzymatic, colorimetric |
| total protein | colorimetric |
| ua (uric acid) | enzymatic, colorimetric |
| uibc (unsaturated iron binding | colorimetric |
| capacity) | |
| urea | enzymatic, kinetic |
| urine protein | colorimetric |

### Preferred Embodiment

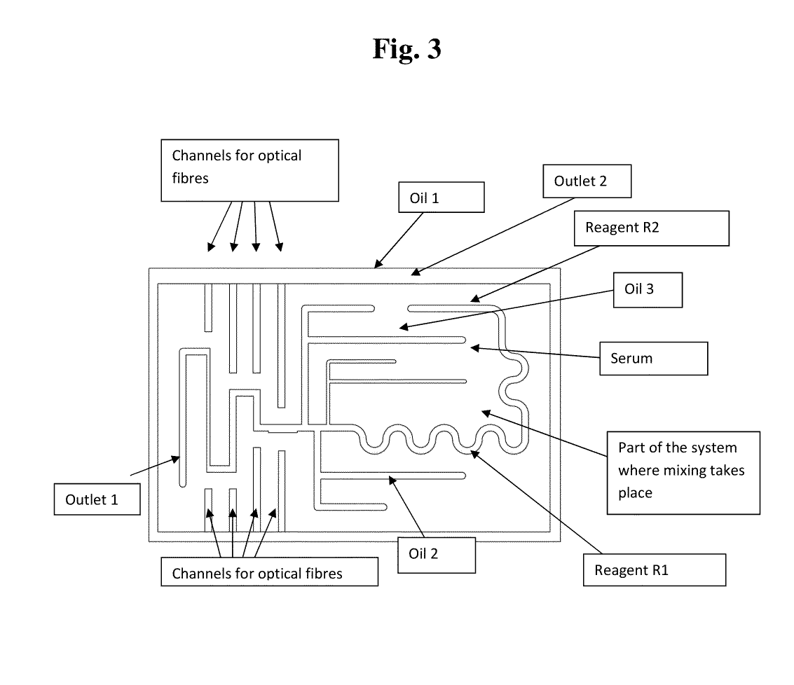

A microfluidic system has been fabricated from polypropylene. The scheme of the system is shown in FIG. 3. The system contains channels with diameter of 400 and 800 μm, and comprises, among others, T-junctions connecting channels with each other. A sample in the form of a serum portion (marked “Serum” in FIG. 3) was introduced into the system and a 100 nl droplet was produced in a T-junction. A portion of reagent (“Reagent R1” in FIG. 3) for amylase assay was introduced into the second channel of the system and a 5 μl droplet was produced in a T-junction. Using hexadecane as a continuous liquid, the sample droplet and the reagent droplet (“Oil 3”, “Oil 2” in FIG. 3, respectively) were transported to the location, where the sample droplet and the reagent droplet merged. The mixing was effected by further pumping the merged droplet through a meandering channel between the outlet 1 and the outlet 2. As a result, chemical reaction took place, and the result of the reaction was measured with a spectrophotometer. Based on the spectrophotometric measurement, the amylase content in the sample was determined.

The microfluidic systems and the method for transporting microdroplets using carrier liquids (continuous liquids) in these systems are known in the state of the art, e.g., from a patent application WO2011/090396. Likely, the method for determining concentrations of, for instance, albumin, bilirubin or creatinine, and many other biochemical parameters in a sample using spectrophotometric analysis is known in the state of the art, whereas the selection of the material for fabrication of the microfluidic system, the carrier liquid and the reagent constitute the element of the present invention.

1. A method for determining biochemical parameters of a body fluid, wherein a sample of said body fluid in the form of a droplet is transported through a channel of a microfluidic system using a carrier liquid, mixed with a reagent thus initiating a chemical reaction between the sample and the reagent, and the result of the chemical reaction is measured, preferably with a spectrophotometer, whereby the said biochemical parameters of the body fluid are determined, characterised in that the material used for fabrication of the microfluidic system and the said carrier liquid is pair of Teflon and Fluorinert HFE-710.

2. Method according to claim 1, characterised in that the said reagent is selected from the group comprising: acp (acid phosphatase), alat (alanine aminotransferase), albumin, alp (alkaline phosphatase), alpha-fetoprotein, alpha-1-microglobulin, amylase, asat (aspartate transaminase), aso (anti-streptolysin O), bil direct (direct bilirubin), bil total (total bilirubin), calcium, ceruloplasmin, cholesterol, cholinesterase, ck (creatine kinase), ck MB (creatine kinase MB), complement C3, complement C4, crp (C-reactive protein), cystatin C, D-dimer D, ethanol, phenobarbital, ferrum, ferritin, fibrinogen, ggt (gamma-glutamyltransferase), glucose, haptoglobin, hbdh (α-hydroxybutyrate dehydrogenase), hdl cholesterol, HbA1C (hemoglobin), immunoglobulin A, immunoglobulin E, immunoglobulin M, carbamazepine, creatinine, alpha-1-acid glycoprotein, ldh (lactate dehydrogenase), ldl cholesterol, lipase, lipoprotein, Mg (magnesium), copper, myoglobin, lactates, paracetamol, phosphorus, potassium, rf (rheumatoid factor), salicylates, sodium, theophylline, tg (triglycerides), total protein, ua (uric acid), uibc (unsaturated iron binding capacity), urea, urine protein.

3. The use of a pair of the material and the liquid Teflon and Fluorinert HFE-7100—for determining biochemical parameters of a body fluid.
